(19) United States
(12) Patent Application Publication
(10) Pub. No.: US 2019/0276610 A1
(43) Pub. Date: Sep. 12, 2019

(54) SLURRY, METHOD OF PRODUCING COMPOSITE RESIN MATERIAL, AND METHOD OF PRODUCING SHAPED PRODUCT

(71) Applicant: ZEON CORPORATION, Chiyoda-ku Tokyo (JP)

(72) Inventors: Yoshihisa TAKEYAMA, Chiyoda-ku, Tokyo (JP); Masahiro UENO, Chiyoda-ku, Tokyo (JP); Noriyuki MITAO, Chiyoda-ku, Tokyo (JP)

(73) Assignee: ZEON CORPORATION, Chiyoda-ku Tokyo (JP)

(21) Appl. No.: 16/335,804

(22) PCT Filed: Oct. 2, 2017
(86) PCT No.: PCT/JP2017/035879

§ 371 Date: Mar. 22, 2019

(30) Foreign Application Priority Data
Oct. 3, 2016 (JP) 2016-195966

(51) Int. Cl. C08J 3/11; C08F 14/26; C08K 3/04; C08J 3/205; B29B 9/02; B29C 43/00; B29C 43/02; B29C 43/52

(52) U.S. Cl. CPC C08J 3/11; C08F 14/26; C08K 3/041; C08J 3/205; B29B 9/02; B82Y 40/00; B29C 43/02; B29C 43/52; C08K 2201/011; C08K 2201/003; C08K 2201/004; B29C 43/003

(57) ABSTRACT

Provided is a composite resin material that enables formation of a shaped product having excellent mechanical strength and sufficiently low surface resistivity. A method of producing the composite resin material includes a step of removing a dispersion medium from a slurry that contains fluororesin particles, fibrous carbon nanostructures, and the dispersion medium, that contains 0.01-0.5 parts by mass of the fibrous carbon nanostructures per 100 parts by mass of the fluororesin particles, and for which an area fraction S (%) of fibrous carbon nanostructure aggregates when the slurry is loaded into a glass slide including an indentation of 0.5 mm in depth and inside of the indentation is observed over a range of 3 mm×2 mm using an optical microscope and a volume percentage V (volume %) of the fibrous carbon nanostructures in solid content of the slurry satisfy a relationship: 3≤S/V≤30.

### TECHNICAL FIELD

The present disclosure relates to a slurry and methods of producing a composite resin material and a shaped product, and, in particular, relates to a slurry containing fluororesin particles and fibrous carbon nanostructures, a method of producing a composite resin material using the slurry, and a method of producing a shaped product using the composite resin material.

### BACKGROUND

Fibrous carbon nanostructures such as carbon nanotubes (hereinafter, also referred to as “CNTs”) are being investigated for use in a wide range of applications due to excelling in terms of electrical conductivity, thermal conductivity, sliding properties, mechanical properties, and so forth.

Moreover, in recent years, development has been ongoing in relation to techniques for exploiting the excellent properties of fibrous carbon nanostructures by combining resin materials and fibrous carbon nanostructures in order to provide composite resin materials that have both resin properties, such as processability and strength, and fibrous carbon nanostructure properties, such as electrical conductivity.

For example, PTL 1 and PTL 2 each propose a composite resin material in which fibrous carbon nanostructures are held in a dispersed manner on the surface of a particulate resin material (hereinafter, also referred to as “resin particles”).

The composite resin material described in PTL 1 is produced by a production method including a step of mixing fibrous carbon nanostructures using ultrasonic waves on the surface of resin particles that have been swollen and softened in subcritical or supercritical carbon dioxide. Through this production method, the fibrous carbon nanostructures are dispersed over almost the entire surface of the resin particles by the action of ultrasonic waves and are also firmly embedded inward from the surface of the resin particles.

The composite resin material described in PTL 2 is produced by a production method including a step of causing adsorption of fibrous carbon nanostructures onto the surface of swollen and softened resin particles by gently stirring a mixed liquid of the fibrous carbon nanostructures and the resin particles in a subcritical or supercritical carbon dioxide atmosphere. Through this production method, composite resin particles can be produced without causing fragmentation of the fibrous carbon nanostructures.

Moreover, composite resin materials containing fibrous carbon nanostructures can be used in production of shaped products having antistatic performance, for example, due to having electrical conductivity.

### CITATION LIST

### Patent Literature

PTL 1: JP 5603059 B

PTL 2: WO 2012/107991 A1

### SUMMARY

### Technical Problem

A shaped product having antistatic performance is required to have excellent mechanical strength, uniform electrical conductivity, and sufficiently low surface resistivity (for example, less than 10⁸ Ω/sq). However, there have been cases in which shaped products formed using the conventional composite resin materials described above have had non-uniform electrical conductivity.

Accordingly, an objective of the present disclosure is to provide a shaped product having excellent mechanical strength and sufficiently low surface resistivity, and a composite resin material that enables formation of this shaped product.

### Solution to Problem

The inventors conducted diligent investigation in order to achieve the objective described above. As a result, the inventors discovered that a shaped product having excellent mechanical strength and also having sufficiently low surface resistivity and excellent antistatic performance can be obtained using a composite resin material obtained by removing a dispersion medium from a slurry that contains fluororesin particles, fibrous carbon nanostructures, and the dispersion medium and that has specific properties. In this manner, the inventors completed the present disclosure.

Specifically, the present disclosure aims to advantageously solve the problem set forth above by disclosing a slurry comprising fluororesin particles, fibrous carbon nanostructures, and a dispersion medium, wherein the fibrous carbon nanostructures are contained in a proportion of at least 0.01 parts by mass and not more than 0.5 parts by mass per 100 parts by mass of the fluororesin particles, and an area fraction S, in units of %, of aggregates of the fibrous carbon nanostructures when the slurry is loaded into a glass slide including an indentation of 0.5 mm in depth and inside of the indentation of the glass slide is observed over a range of 3 mm×2 mm using an optical microscope and a volume percentage V, in units of volume %, of the fibrous carbon nanostructures in solid content of the slurry satisfy a relationship: 3≤S/V≤30. Through use of a slurry containing fibrous carbon nanostructures in the prescribed proportion and having the prescribed property as set forth above, it is possible to obtain a composite resin material that enables formation of a shaped product having excellent mechanical strength and sufficiently low surface resistivity.

In the presently disclosed slurry, the fibrous carbon nanostructures preferably have an average diameter of at least 1 nm and not more than 60 nm and an average length of 10 μm or more. This is because surface resistivity of a shaped product obtained using the slurry can be further reduced when the average diameter and the average length of the fibrous carbon nanostructures are within the ranges set forth above.

The “average diameter of fibrous carbon nanostructures” referred to in the present disclosure can be determined by measuring the diameters (external diameters) of 20 fibrous carbon nanostructures, for example, in a transmission electron microscope (TEM) image and then calculating a number-average value of the diameters. The “average length of fibrous carbon nanostructures” can be determined by measuring the lengths of 20 fibrous carbon nanostructures, for example, in a scanning electron microscope (SEM) image and then calculating a number-average value of the lengths.

In the presently disclosed slurry, the fibrous carbon nanostructures preferably exhibit a convex upward shape in a t-plot obtained from an adsorption isotherm. This is because surface resistivity of a shaped product obtained using the slurry can be further reduced when fibrous carbon nanostructures that exhibit a convex upward shape in a t-plot are used.

In the presently disclosed slurry, the dispersion medium preferably has a Hansen solubility parameter dispersion term dD of at least 16 and not more than 22 and a Hansen solubility parameter hydrogen bonding term dH of at least 0 and not more than 6. This is because surface resistivity of a shaped product can be further reduced using a slurry in which a dispersion medium having the properties set forth above is used.

In the presently disclosed slurry, the dispersion medium is preferably at least one selected from the group consisting of cyclohexane, xylene, methyl ethyl ketone, and toluene. This is because surface resistivity of a shaped product can be further reduced by using a slurry in which at least one selected from the group consisting of cyclohexane, xylene, methyl ethyl ketone, and toluene is used as a dispersion medium.

Moreover, the present disclosure aims to advantageously solve the problem set forth above by disclosing a method of producing a composite resin material comprising a step of removing the dispersion medium from any one of the slurries set forth above to form a composite resin material. By removing the dispersion medium from the slurry, it is possible to obtain a composite resin material that enables formation of a shaped product having excellent mechanical strength and sufficiently low surface resistivity.

Furthermore, the present disclosure aims to advantageously solve the problem set forth above by disclosing a method of producing a shaped product comprising a step of shaping a composite resin material produced using the method of producing a composite resin material set forth above. By using a composite resin material produced using the method of producing a composite resin material set forth above, it is possible to obtain a shaped product having excellent mechanical strength and sufficiently low surface resistivity.

### Advantageous Effect

A composite resin material that enables formation of a shaped product having excellent mechanical strength and sufficiently low surface resistivity can be obtained using the presently disclosed slurry.

Moreover, a composite resin material that enables formation of a shaped product having excellent mechanical strength and sufficiently low surface resistivity is obtained through the presently disclosed method of producing a composite resin material.

Furthermore, a shaped product having excellent mechanical strength and sufficiently low surface resistivity is obtained through the presently disclosed method of producing a shaped product.

### DETAILED DESCRIPTION

The following provides a detailed description of embodiments of the present disclosure.

The presently disclosed slurry can be used in production of a composite resin material using the presently disclosed method of producing a composite resin material. Moreover, a composite resin material produced using the presently disclosed method of producing a composite resin material can be used in production of a shaped product using the presently disclosed method of producing a shaped product. Furthermore, a shaped product produced using the presently disclosed method of producing a shaped product is useful as an integrated circuit tray, a wafer carrier, or a sealing material, for example, due to having low surface resistivity and displaying antistatic performance, but is not specifically limited to these uses.

(Slurry)

The presently disclosed slurry contains fluororesin particles, fibrous carbon nanostructures, and a dispersion medium, and may optionally further contain additives such as a dispersant. The presently disclosed slurry contains the fibrous carbon nanostructures in a proportion of at least 0.01 parts by mass and not more than 0.5 parts by mass per 100 parts by mass of the fluororesin particles. In addition, an area fraction S (%) of aggregates of the fibrous carbon nanostructures when the presently disclosed slurry is loaded into a glass slide including an indentation of 0.5 mm in depth and the inside of the indentation of the glass slide is observed over a range of 3 mm×2 mm using an optical microscope and a volume percentage V (volume %) constituted by the fibrous carbon nanostructures among all solid content (100 volume %) of the slurry satisfy a prescribed relationship.

As a result of the presently disclosed slurry containing the fibrous carbon nanostructures in the prescribed proportion and having an area fraction S (%) and a volume percentage V (volume %) that satisfy the prescribed relationship, a shaped product having excellent mechanical strength and sufficiently low surface resistivity can be obtained using a composite resin material obtained by removing the dispersion medium from the slurry.

<Fluororesin Particles>

A fluororesin forming the fluororesin particles is a polymer that includes a fluorine-containing monomer unit. The phrase “including a monomer unit” as used in the present description means that “a polymer obtained with the monomer includes a repeating unit derived from the monomer”.

The fluororesin may, for example, be polytetrafluoroethylene (PTFE), tetrafluoroethylene-perfluoroalkyl vinyl ether copolymer (PFA), tetrafluoroethylene-hexafluoropropylene copolymer (FEP), tetrafluoroethylene-ethylene copolymer (ETFE), polychlorotrifluoroethylene (PCTFE), chlorotrifluoroethylene-ethylene copolymer (ECTFE), polyvinylidene fluoride (PVDF), polyvinyl fluoride (PVF), or the like. Of these examples, the fluororesin is preferably PTFE or PFA, and more preferably PTFE.

Note that the fluororesin particles may be formed by one type of fluororesin, or may be formed by two or more types of fluororesins.

The average particle diameter of the fluororesin particles is preferably 1 μm or more, more preferably 5 μm or more, and even more preferably 10 μm or more, and is preferably 700 μm or less, more preferably 250 μm or less, and even more preferably 150 μm or less. Mechanical strength and electrical conductivity of a shaped product can be improved when the average particle diameter of the fluororesin particles is 1 μm or more. Moreover, slurry producibility can be improved when the average particle diameter of the fluororesin particles is 700 μm or less.

The “average particle diameter” of fluororesin particles referred to in the present disclosure can be determined by measuring a particle size distribution (volume basis) of the fluororesin particles by laser diffraction and then calculating a particle diameter at which a cumulative value of volume probability density reaches 50%.

<Fibrous Carbon Nanostructures>

No specific limitations are placed on the fibrous carbon nanostructures. For example, fibrous carbon nanostructures having electrical conductivity may be used. Specific examples of usable fibrous carbon nanostructures include cylindrical carbon nanostructures such as carbon nanotubes (CNTs) and non-cylindrical carbon nanostructures such as carbon nanostructures having a network of 6-membered carbon rings in the form of flattened cylindrical shape. One type of fibrous carbon nanostructure may be used individually, or two or more types of fibrous carbon nanostructures may be used in combination.

Of the above-described examples, fibrous carbon nanostructures including CNTs are preferably used as the fibrous carbon nanostructures. This is because by using fibrous carbon nanostructures that include CNTs, it is possible to efficiently impart electrical conductivity to a composite resin material and a shaped product and reduce surface resistivity of the shaped product even using only a small amount of the fibrous carbon nanostructures.

The fibrous carbon nanostructures including CNTs may be composed of only CNTs or may be a mixture of CNTs and fibrous carbon nanostructures other than CNTs.

The CNTs included among the fibrous carbon nanostructures are not specifically limited and may be single-walled carbon nanotubes and/or multi-walled carbon nanotubes. However, the CNTs are preferably carbon nanotubes having one to five walls, and are more preferably single-walled carbon nanotubes. This is because electrical conductivity of a composite resin material and a shaped product can be improved and surface resistivity of the shaped product can be reduced using a smaller amount of carbon nanotubes when carbon nanotubes having fewer walls are used.

The average diameter of the fibrous carbon nanostructures is preferably 1 nm or more, and is preferably 60 nm or less, more preferably 30 nm or less, and even more preferably 10 nm or less. Electrical conductivity can be imparted to a composite resin material and a shaped product in a stable manner when the average diameter of the fibrous carbon nanostructures is 1 nm or more. Moreover, electrical conductivity can be efficiently imparted to a composite resin material and a shaped product even using only a small amount of fibrous carbon nanostructures and shaped product mechanical strength can be improved when the average diameter of the fibrous carbon nanostructures is 60 nm or less. Therefore, sufficient shaped product mechanical strength can be ensured while also sufficiently reducing shaped product surface resistivity when the average diameter of the fibrous carbon nanostructures is within any of the ranges set forth above.

The fibrous carbon nanostructures are preferably fibrous carbon nanostructures for which a ratio 3σ/Av of a value 3σ (value obtained by multiplying the diameter standard deviation (σ: sample standard deviation) by 3) relative to the average diameter Av is more than 0.20 and less than 0.60, more preferably fibrous carbon nanostructures for which 3σ/Av is more than 0.25, and even more preferably fibrous carbon nanostructures for which 3σ/Av is more than 0.40. Performance of a produced composite resin material and shaped product can be further improved when fibrous carbon nanostructures for which 3σ/Av is more than 0.20 and less than 0.60 are used.

The average diameter Av and the standard deviation σ of the fibrous carbon nanostructures may be adjusted by altering the production method and the production conditions of the fibrous carbon nanostructures, or by combining a plurality of types of fibrous carbon nanostructures obtained by different production methods.

The fibrous carbon nanostructures that are used typically take a normal distribution when a plot is made of diameter measured as described above on a horizontal axis and probability density thereof on a vertical axis, and a Gaussian approximation is made.

The average length of the fibrous carbon nanostructures is preferably 10 μm or more, more preferably 50 μm or more, and even more preferably 80 μm or more, and is preferably 600 μm or less, more preferably 500 μm or less, and even more preferably 400 μm or less. A conduction path can be formed in a composite resin material and a shaped product using a small amount of fibrous carbon nanostructures when the average length thereof is at least any of the lower limits set forth above. Moreover, electrical conductivity of a composite resin material and a shaped product can be stabilized when the average length is not more than any of the upper limits set forth above. Therefore, shaped product surface resistivity can be sufficiently reduced when the average length of the fibrous carbon nanostructures is within any of the ranges set forth above.

The fibrous carbon nanostructures normally have an aspect ratio of more than 10. The aspect ratio of the fibrous carbon nanostructures can be determined by measuring the diameters and lengths of 100 randomly selected fibrous carbon nanostructures using a scanning electron microscope or a transmission electron microscope, and then calculating an average value for the ratio of diameter and length (length/diameter).

The BET specific surface area of the fibrous carbon nanostructures is preferably 200 m²/g or more, more preferably 400 m²/g or more, and even more preferably 600 m²/g or more, and is preferably 2,000 m²/g or less, more preferably 1,800 m²/g or less, and even more preferably 1,600 m²/g or less. When the BET specific surface area of the fibrous carbon nanostructures is 200 m²/g or more, electrical conductivity of a composite resin material and a shaped product can be sufficiently increased and surface resistivity of the shaped product can be sufficiently reduced using a small amount of the fibrous carbon nanostructures, and shaped product mechanical strength can also be improved. Moreover, electrical conductivity of a composite resin material and a shaped product can be stabilized when the BET specific surface area of the fibrous carbon nanostructures is 2,000 m²/g or less.

Herein, the term “BET specific surface area” refers to nitrogen adsorption specific surface area measured by the BET method.

The fibrous carbon nanostructures preferably exhibit a convex upward shape in a t-plot obtained from an adsorption isotherm. The t-plot can be obtained from an adsorption isotherm of the fibrous carbon nanostructures measured by a nitrogen gas adsorption method by converting relative pressure to an average thickness t (nm) of an adsorbed layer of nitrogen gas. Specifically, an average adsorbed nitrogen gas layer thickness t corresponding to a given relative pressure is determined from a known standard isotherm of average adsorbed nitrogen gas layer thickness t plotted against relative pressure P/P0 to perform this conversion and obtain a t-plot for the fibrous carbon nanostructures (t-plot method of de Boer et al.).

In the case of a material having pores at the surface thereof, growth of the adsorbed layer of nitrogen gas is categorized into the following processes (1) to (3). The gradient of the t-plot changes in accordance with processes (1) to (3).

(1) A process in which a single molecular adsorption layer of nitrogen molecules is formed over the entire surface

(2) A process in which a multi-molecular adsorption layer is formed and is accompanied by capillary condensation filling of pores

(3) A process in which a multi-molecular adsorption layer is formed at a surface that appears to be non-porous due to the pores being filled by nitrogen

The t-plot forming a convex upward shape is on a straight line passing through the origin in a region in which the average adsorbed nitrogen gas layer thickness t is small, but, as t increases, the plot deviates downward from the straight line. When fibrous carbon nanostructures have a t-plot shape such as described above, this indicates that the fibrous carbon nanostructures have a large ratio of internal specific surface area relative to total specific surface area and that there is a large number of openings in carbon nanostructures constituting the fibrous carbon nanostructures.

A bending point of the t-plot for the fibrous carbon nanostructures is preferably within a range of 0.2≤t (nm)≤1.5, more preferably within a range of 0.45≤t (nm)≤1.5, and even more preferably within a range of 0.55≤t (nm)≤1.0. When the bending point of the t-plot for the fibrous carbon nanostructures is within any of the ranges set forth above, electrical conductivity of a composite resin material and a shaped product can be increased using a small amount of the fibrous carbon nanostructures.

The “position of the bending point” is defined as an intersection point of a linear approximation A for the above-described process (1) and a linear approximation B for the above-described process (3).

The fibrous carbon nanostructures preferably have a ratio (S2/S1) of internal specific surface area S2 relative to total specific surface area S1 obtained from the t-plot of at least 0.05 and not more than 0.30. When the value of S2/S1 of the fibrous carbon nanostructures is within the range set forth above, electrical conductivity of a composite resin material and a shaped product can be increased using a small amount of the fibrous carbon nanostructures, and shaped product mechanical strength can also be improved.

The total specific surface area S1 and the internal specific surface area S2 of the fibrous carbon nanostructures can be determined from the t-plot for the fibrous carbon nanostructures. Specifically, the total specific surface area S1 and external specific surface area S3 can first be determined from the gradient of the linear approximation of process (1) and the gradient of the linear approximation of process (3), respectively. The internal specific surface area S2 can then be calculated by subtracting the external specific surface area S3 from the total specific surface area S1.

Measurement of an adsorption isotherm of the fibrous carbon nanostructures, preparation of a t-plot, and calculation of total specific surface area S1 and internal specific surface area S2 based on t-plot analysis can be performed, for example, using a BELSORP®-mini (BELSORP is a registered trademark in Japan, other countries, or both), which is a commercially available measurement apparatus produced by Bel Japan Inc.

Moreover, it is preferable that the fibrous carbon nanostructures including CNTs that are preferable as the fibrous carbon nanostructures have a radial breathing mode (RBM) peak when evaluated by Raman spectroscopy. It should be noted that an RBM is not present in the Raman spectrum of fibrous carbon nanostructures composed only of multi-walled carbon nanotubes having three or more walls.

In a Raman spectrum of the fibrous carbon nanostructures including CNTs, a ratio of G band peak intensity relative to D band peak intensity (G/D ratio) is preferably at least 0.5 and not more than 5.0. Performance of a produced composite resin material and shaped product can be further improved when the G/D ratio is at least 0.5 and not more than 5.0.

The fibrous carbon nanostructures including CNTs can be produced by a known CNT synthetic method such as arc discharge, laser ablation, or chemical vapor deposition (CVD) without any specific limitations. Specifically, the fibrous carbon nanostructures including CNTs can, for example, be efficiently produced in accordance with a method in which, during synthesis of CNTs through chemical vapor deposition (CVD) by supplying a feedstock compound and a carrier gas onto a substrate having a catalyst layer for carbon nanotube production at the surface thereof, a trace amount of an oxidizing agent (catalyst activating material) is provided in the system to dramatically improve the catalytic activity of the catalyst layer (super growth method; refer to WO 2006/011655 A1). Hereinafter, carbon nanotubes that are obtained by the super growth method are also referred to as “SGCNTs”.

The fibrous carbon nanostructures produced by the super growth method may be composed of only SGCNTs or may include other carbon nanostructures such as non-cylindrical carbon nanostructures in addition to SGCNTs.

The amount of fibrous carbon nanostructures contained in the slurry per 100 parts by mass of the previously described fluororesin particles is required to be at least 0.01 parts by mass and not more than 0.5 parts by mass, is preferably 0.02 parts by mass or more, more preferably 0.03 parts by mass or more, and even more preferably 0.06 parts by mass or more, and is preferably 0.25 parts by mass or less, more preferably 0.2 parts by mass or less, and even more preferably 0.15 parts by mass or less. When the amount of the fibrous carbon nanostructures is at least any of the lower limits set forth above, electrical conductivity of a composite resin material and a shaped product can be increased, surface resistivity of the shaped product can be sufficiently reduced, and sufficient shaped product mechanical strength can also be ensured. Moreover, the occurrence of non-uniform electrical conductivity of a shaped product can be inhibited when the amount of the fibrous carbon nanostructures is not more than any of the upper limits set forth above. Therefore, sufficient shaped product mechanical strength can be ensured while also causing the shaped product to display sufficient antistatic performance when the amount of the fibrous carbon nanostructures is within any of the ranges set forth above.

<Dispersion Medium>

Any dispersion medium in which the fluororesin particles and the fibrous carbon nanostructures can be dispersed may be used as the dispersion medium without any specific limitations. In particular, it is preferable to use a solvent having a Hansen solubility parameter dispersion term dD of at least 16 and not more than 22 and a Hansen solubility parameter hydrogen bonding term dH of at least 0 and not more than 6 as the dispersion medium. Specific examples of dispersion media that may be used include diisobutyl ketone (dD=16, dH=4.1), cyclopentane (dD=16.4, dH=1.8), xylene (dD=17.6, dH=3.1), toluene (dD=18, dH=2), cyclohexane (dD=16.8, dH=0.2), chlorobenzene (dD=19, dH=2), isophorone (dD=17, dH=5), methyl ethyl ketone (dD=16, dH=5.1), 1,2-dichlorobenzene (dD=19.2, dH=3.3), cyclohexanone (dD=17.8, dH=5.1), carbon disulfide (dD=20.2, dH=0.6), cyclopentanone (dD=17.9, dH=5.2), nitrobenzene (dD=20, dH=4.1), acetophenone (dD=19.6, dH=3.7), tetrahydronaphthalene (dD=19, dH=5.9), bis(m-phenoxyphenyl)ether (dD=19.6, dH=5.1), naphthalene (dD=19.2, dH=5.9), 1-methylnaphthalene (dD=20.6, dH=4.7), cyclobutanone (dD=18.3, dH=5.2), chloroform (dD=17.8, dH=5.7), and pyridine (dD=19, dH=5.9). One of these solvents may be used individually, or two or more of these solvents may be used in combination in a freely selected ratio.

Of these solvents, it is preferable to use at least one selected from the group consisting of cyclohexane, xylene, methyl ethyl ketone, and toluene as the dispersion medium, and more preferable to use cyclohexane as the dispersion medium from a viewpoint of further reducing surface resistivity of a shaped product obtained used the slurry.

<Additives>

No specific limitations are placed on additives that may optionally be contained in the slurry and examples thereof include known additives such as dispersants.

Examples of dispersants that may be used include known dispersants that can assist dispersion of fibrous carbon nanostructures. Specifically, a surfactant, a polysaccharide, a π-conjugated polymer, a polymer including an ethylene chain as a main chain, or the like may be used as a dispersant. Of these dispersants, a surfactant is more preferable.

The amount of additives in the slurry per 100 parts by mass of the previously described fluororesin particles is preferably 5 parts by mass or less, and more preferably 0 parts by mass (i.e., the slurry does not contain additives) from a viewpoint of suppressing reduction in electrical conductivity of a composite resin material and a shaped product.

<Slurry Properties>

An area fraction S (%) of aggregates of the fibrous carbon nanostructures when the presently disclosed slurry is loaded into a glass slide including an indentation of 0.5 mm in depth and the inside of the indentation of the glass slide is observed over a range of 3 mm×2 mm using an optical microscope and a volume percentage V (volume %) constituted by the fibrous carbon nanostructures among all solid content of the slurry are required to satisfy a relationship: 3≤S/V≤30, and preferably satisfy a relationship: 5≤S/V≤25. When the ratio (S/V) of the area fraction S relative to the volume percentage V is at least any of the lower limits set forth above, the fibrous carbon nanostructures can favorably form a conduction path in a shaped product, and electrical conductivity of the shaped product can be increased. Moreover, when the ratio (S/V) of the area fraction S relative to the volume percentage V is not more than any of the upper limits set forth above, the occurrence of non-uniform electrical conductivity in a shaped product can be inhibited. Therefore, a shaped product can be caused to display sufficient antistatic performance when S/V is within any of the ranges set forth above. Moreover, shaped product mechanical strength can be ensured when the ratio (S/V) of the area fraction S relative to the volume percentage V is not more than any of the upper limits set forth above.

The area fraction S (%) of aggregates of the fibrous carbon nanostructures can be adjusted by, for example, altering the mixing and dispersing conditions of the fluororesin particles, the fibrous carbon nanostructures, and the dispersion medium, the type of dispersion medium, and the type, properties, and amount of the fibrous carbon nanostructures. Specifically, the area fraction S (%) can be increased by adopting conditions that facilitate aggregation of the fibrous carbon nanostructures as the mixing and dispersing conditions and by using fibrous carbon nanostructures having a high tendency to aggregate.

<Production Method of Slurry>

The slurry set forth above can be produced without any specific limitations by, for example, subjecting a mixed liquid containing the fluororesin particles, the fibrous carbon nanostructures, the dispersion medium, and optional additives to dispersion treatment, or by adding a portion of the fluororesin particles, the fibrous carbon nanostructures, and optional additives to the dispersion medium and then subjecting the resultant mixed liquid to addition of the remainder of the fluororesin particles, the fibrous carbon nanostructures, and the optional additives and to dispersion treatment. In other words, the slurry can be produced by mixing and dispersing the fluororesin particles, the fibrous carbon nanostructures, the dispersion medium, and optional additives in a single step or by mixing and dispersing the fluororesin particles, the fibrous carbon nanostructures, the dispersion medium, and optional additives over multiple steps.

In particular, it is preferable that the slurry is produced by subjecting a mixed liquid containing the fluororesin particles, the fibrous carbon nanostructures, the dispersion medium, and optional additives to dispersion treatment.

From a viewpoint of easily obtaining a slurry having the properties set forth above, the dispersion treatment used in production of the slurry is preferably wet dispersion treatment using a wet mixing and dispersing machine such as a propeller mixer, a high-speed mixer, a dissolver, a homogenizer, an ultimizer, a wet jet mill, a colloid mill, a masscolloider, a bead mill, a sand mill, a ball mill, a sand grinder, an inline mixer, or a medialess high-speed stirring disperser. Of these examples, wet dispersion treatment using a medialess wet mixing and dispersing machine is preferable, wet dispersion treatment using a homogenizer or an inline mixer is more preferable, and wet dispersion treatment using a homogenizer is particularly preferable. The pressure acting on the mixed liquid in this dispersion treatment is preferably 5 MPa or less.

(Method of Producing Composite Resin Material)

The presently disclosed method of producing a composite resin material includes a step of removing the dispersion medium from the presently disclosed slurry to form a composite resin material. As a result of the slurry set forth above being used in the presently disclosed method of producing a composite resin material, it is possible to obtain a composite resin material that enables formation of a shaped product having excellent mechanical strength and sufficiently low surface resistivity.

Known methods such as drying and filtration can be used without any specific limitations as the method by which the dispersion medium is removed from the slurry. Of such methods, the method by which the dispersion medium is removed is preferably drying, more preferably vacuum drying, drying through ventilation of an inert gas, drying using a spray dryer, or drying using a CD dryer, and even more preferably vacuum drying, drying using a spray dryer, or drying using a CD dryer.

In the presently disclosed method of producing a composite resin material, a composite of the fluororesin and the fibrous carbon nanostructures that is obtained by removing the dispersion medium from the slurry may be used, as produced, as the composite resin material, or the composite may be granulated by any method such as milling or flaking to obtain the composite resin material.

(Method of Producing Shaped Product)

The presently disclosed method of producing a shaped product includes a step of shaping the composite resin material produced using the method of producing a composite resin material. As a result of the composite resin material set forth above being used in the presently disclosed method of producing a shaped product, it is possible to obtain a shaped product having excellent mechanical strength and sufficiently low surface resistivity.

Known shaping methods such as compression molding can be used without any specific limitations as the method by which the composite resin material is shaped. The shaped product obtained through shaping of the composite resin material may optionally be subjected to firing treatment.

The surface resistivity of the shaped product obtained using the presently disclosed method of producing a shaped product is less than 1×10⁸Ω/sq, for example, and is preferably less than 1×10⁷Ω/sq.

### EXAMPLES

The following provides a more specific description of the present disclosure based on examples. However, the present disclosure is not limited to the following examples. In the following description, “%” and “parts” used in expressing quantities are by mass, unless otherwise specified.

In the examples and comparative examples, the following methods were used to measure and evaluate the area fraction of fibrous carbon nanostructure aggregates, the volume percentage of fibrous carbon nanostructures, and the surface resistivity and tensile strength of a shaped product.

<Area Fraction of Fibrous Carbon Nanostructure Aggregates>

A produced slurry was tightly sealed in a glass slide including an indentation of 0.5 mm in depth (produced by Shimadzu Corporation; name: Glass Sample Plate (0.5 mm)). A 3 mm×2 mm field of view (×100 magnification) was observed using a digital microscope (produced by Keyence Corporation; product name: VHX-900) under side illumination, and an image was acquired. Image processing software (produced by Mitani Corporation; product name: WinROOF 2015) was used to perform binarization of the acquired image and subsequently measure the area of aggregates of fibrous carbon nanostructures in the image to determine the total area (Sc) of fibrous carbon nanostructure aggregates in a 3 mm×2 mm range. The determined value was divided by the observation field area (St) to determine an area fraction (S) of the fibrous carbon nanostructure aggregates.

S=(Sc/St)×100(%)

<Volume Percentage of Fibrous Carbon Nanostructures>

A composite resin material (all solid content) obtained through removal of a dispersion medium from a slurry was used to determine the volume percentage of fibrous carbon nanostructures.

Specifically, a thermogravimetric analyzer (produced by TA Instruments; product name: Discovery TGA) was used to heat a produced composite resin material under a nitrogen atmosphere in a temperature range of room temperature to 700° C. with a heating rate of 20° C./min and then hold the composite resin material at 700° C. for 5 minutes to cause thermal decomposition of resin (fluororesin). The weight (W_{P}) of resin in the composite resin material was calculated. Next, the nitrogen atmosphere was switched to an air atmosphere and the composite resin material was held at 700° C. under the air atmosphere for 5 minutes to cause decomposition of fibrous carbon nanostructures, and thereby calculate the weight (W_{C}) of fibrous carbon nanostructures in the composite resin material. The volume percentage (V) of the fibrous carbon nanostructures in solid content contained in the slurry was calculated from the specific gravity (ρ_{P}) of the resin and the specific gravity (ρ_{C}) of the fibrous carbon nanostructures using the following formula.

V=(W_{C}/ρ_{C})/{(W_{P}/ρ_{P})+(W_{C}/ρ_{C})}×100 (%)

<Surface Resistivity>

The surface of a post-firing shaped product was polished using waterproof abrasive paper (#3000) and then surface resistivity (Ω/sq) of the shaped product was measured using a resistivity meter (produced by Mitsubishi Chemical Analytech Co., Ltd.; product name: Hiresta MCP-HT800; probe: URSS).

<Tensile Strength and Elongation>

A specimen was obtained by punching out a dumbbell shape (JIS K7137-2; in accordance with Type A standard) from a post-firing shaped product. Tensile strength and tensile elongation were measured at 23° C. in accordance with JIS K7137-1 using the obtained specimen. Higher tensile strength and tensile elongation at 23° C. indicate better mechanical properties.

Note that a shaped product that is shaped using a composite resin material containing fibrous carbon nanostructures may have lower tensile strength than a shaped product that is shaped using a resin material that does not contain fibrous carbon nanostructures. In the present disclosure, a ratio of tensile strength (tensile strength of shaped product shaped using composite resin material containing fibrous carbon nanostructures/tensile strength of shaped product shaped using resin material not containing fibrous carbon nanostructures) is preferably 0.80 or more, more preferably 0.85 or more, and even more preferably 0.90 or more.

Addition of fibrous carbon nanostructures may reduce tensile elongation in the same way as for tensile strength. In the present disclosure, a ratio of tensile elongation (tensile elongation of shaped product shaped using composite resin material containing fibrous carbon nanostructures/tensile elongation of shaped product shaped using resin material not containing fibrous carbon nanostructures) is preferably 0.80 or more.

### Example 1

A 1 L SUS (stainless steel) can was charged with 400 g of cyclohexane (Hansen solubility parameters: dD=16.8, dH=0.2) as a dispersion medium, 100 g of fluororesin particles (produced by Daikin Industries, Ltd.; PTFE (polytetrafluoroethylene) molding powder; product name: POLYFLON PTFE-M12; average particle diameter: 50 μm; specific gravity: 2.16), and 0.1 g of carbon nanotubes (produced by Zeon Nano Technology Co., Ltd.; product name: ZEONANO SG101; single-walled CNTs; specific gravity: 1.7; average diameter: 3.5 nm; average length: 400 μm; BET specific surface area: 1,050 m²/g; G/D ratio: 2.1; convex upward shaped t-plot) as fibrous carbon nanostructures, and was stirred for 60 minutes at 20° C. and a rotation speed of 10,000 rpm using a homogenizer (produced by PRIMIX Corporation; product name: LABOLUTION® (LABOLUTION is a registered trademark in Japan, other countries, or both), NEO MIXER® (NEO MIXER is a registered trademark in Japan, other countries, or both)) to obtain a slurry containing fluororesin particles and carbon nanotubes. The area fraction S of aggregates of fibrous carbon nanostructures (carbon nanotubes) was measured using the obtained slurry. The results are shown in Table 1.

Next, centrifugal separation of the slurry was performed using a centrifugal separator (produced by Thinky Corporation; product name: Planetary Centrifugal Mixer THINKY MIXER ARE-310) and then supernatant dispersion medium was removed. Thereafter, vacuum drying was performed for 12 hours at 80° C. using a vacuum dryer (produced by Yamato Scientific Co., Ltd.) to obtain a composite (composite resin material) of a fluororesin and carbon nanotubes. The volume percentage V of fibrous carbon nanostructures was determined using the obtained composite (composite resin material). Next, the obtained composite was milled using a mill mixer and particles of the composite resin material were loaded into a mold. Preliminary shaping was performed using a compression molding machine (produced by Dumbbell Co., Ltd.; model no.: SDOP-10321V-2HC-AT) under conditions of a temperature of 20° C., a pressure of 21 MPa, and a pressure holding time of 5 minutes to obtain a preliminary shaped product in the form of a sheet of 130 mm (length)×80 mm (width)×20 mm (thickness). The preliminary shaped product was removed from the mold and was fired for 6 hours at 370° C. in a free state inside a convection furnace to obtain a shaped product. Surface resistivity, tensile strength, and tensile elongation were evaluated using the obtained shaped product. The results are shown in Table 1.

### Example 2

A slurry, a composite resin material, and a shaped product were produced in the same way as in Example 1 with the exception that in production of the slurry, the homogenizer rotation speed was changed to 15,000 rpm and the stirring time was changed to 30 minutes. Evaluations were performed in the same way as in Example 1. The results are shown in Table 1.

### Example 3

A slurry, a composite resin material, and a shaped product were produced in the same way as in Example 1 with the exception that toluene (Hansen solubility parameters: dD=18, dH=2) was used as the dispersion medium in production of the slurry. Evaluations were performed in the same way as in Example 1. The results are shown in Table 1.

### Example 4

A slurry, a composite resin material, and a shaped product were produced in the same way as in Example 1 with the exception that p-xylene (Hansen solubility parameters: dD=17.6, dH=3.1) was used as the dispersion medium in production of the slurry. Evaluations were performed in the same way as in Example 1. The results are shown in Table 1.

### Example 5

A slurry, a composite resin material, and a shaped product were produced in the same way as in Example 1 with the exception that the amount of carbon nanotubes used in production of the slurry was set as 0.05 g. Evaluations were performed in the same way as in Example 1. The results are shown in Table 1.

### Example 6

A slurry, a composite resin material, and a shaped product were produced in the same way as in Example 1 with the exception that the amount of carbon nanotubes used in production of the slurry was set as 0.2 g. Evaluations were performed in the same way as in Example 1. The results are shown in Table 1.

### Comparative Example 1

A slurry, a composite resin material, and a shaped product were produced in the same way as in Example 1 with the exception that in production of the slurry, the homogenizer rotation speed was changed to 5,000 rpm and the stirring time was changed to 30 minutes. Evaluations were performed in the same way as in Example 1. The results are shown in Table 1.

### Comparative Example 2

A slurry, a composite resin material, and a shaped product were produced in the same way as in Example 1 with the exception that in production of the slurry, a slurry was obtained by performing dispersion treatment with a pressure of 100 MPa using a wet jet mill (produced by Yoshida Kikai Co., Ltd.; product name: L-ES007) instead of a homogenizer. Evaluations were performed in the same way as in Example 1. The results are shown in Table 1.

### Comparative Example 3

A slurry, a composite resin material, and a shaped product were produced in the same way as in Example 1 with the exception that ethyl acetate (Hansen solubility parameters: dD=15.8, dH=7.2) was used as the dispersion medium in production of the slurry. Evaluations were performed in the same way as in Example 1. The results are shown in Table 1.

### Comparative Example 4

A slurry, a composite resin material, and a shaped product were produced in the same way as in Example 1 with the exception that acetone (Hansen solubility parameters: dD=15.5, dH=7) was used as the dispersion medium in production of the slurry. Evaluations were performed in the same way as in Example 1. The results are shown in Table 1.

### Comparative Example 5

A slurry, a composite resin material, and a shaped product were produced in the same way as in Example 1 with the exception that the amount of carbon nanotubes used in production of the slurry was set as 1.0 g. Evaluations were performed in the same way as in Example 1. The results are shown in Table 1.

### Reference Example

A shaped product was produced in the same way as in Example 1 using only the fluororesin particles used in Example 1 (produced by Daikin Industries, Ltd.; PTFE (polytetrafluoroethylene) molding powder; product name: POLYFLON PTFE-M12; average particle diameter: 50 μm; specific gravity: 2.16). Evaluations were performed in the same way as in Example 1. The results are shown in Table 1.

TABLE 1

| | | | Example | Example | Example | Example | Example | Example | Comparative |
|---|---|---|---|---|---|---|---|---|---|
| | | | 1 | 2 | 3 | 4 | 5 | 6 | Example 1 |
| Slurry | Fluororesin particles [parts by mass] | | 100 | 100 | 100 | 100 | 100 | 100 | 100 |
| composition | Carbon nanotubes [parts by mass] | | 0.1 | 0.1 | 0.1 | 0.1 | 0.05 | 0.2 | 0.1 |
| | Dispersion | Ethyl acetate [parts by mass] | — | — | — | — | — | — | — |
| | medium | Acetone [parts by mass] | — | — | — | — | — | — | — |
| | | Cyclohexane [parts by mass] | 400 | 400 | — | — | 400 | 400 | 400 |
| | | Toluene [parts by mass] | — | — | 400 | — | — | — | — |
| | | p-Xylene [parts by mass] | — | — | — | 400 | — | — | — |
| Production | Jet mill | Pressure [MPa] | — | — | — | — | — | — | — |
| method | Homogenizer | Rotation speed [rpm] | 10000 | 15000 | 10000 | 10000 | 10000 | 10000 | 5000 |
| | | Time [min] | 60 | 30 | 60 | 60 | 60 | 60 | 30 |

| | | | | | | | | |
|---|---|---|---|---|---|---|---|---|
| Evaluation | Area fraction S [%] | 1.0 | 2.9 | 1.4 | 1.2 | 1.0 | 5.0 | 7.2 |
| results | Volume percentage V [%] | 0.128 | 0.128 | 0.128 | 0.128 | 0.064 | 0.256 | 0.128 |
| | S/V [—] | 7.8 | 22.7 | 10.9 | 9.4 | 15.0 | 19.6 | 56.3 |
| | Surface resistivity [Ω/sq] | 3.3 × 10⁶ | 2.6 × 10⁶ | 4.4 × 10⁶ | 2.7 × 10⁷ | 9 × 10⁷ | 3 × 10⁴ | 1.8 × 10¹⁰ |
| | Tensile strength (@23° C.) [MPa] | 35 | 34.5 | 32.9 | 35.9 | 36 | 33 | 29.1 |

| | | | | | | | |
|---|---|---|---|---|---|---|---|
| Ratio relative to | 0.94 | 0.92 | 0.88 | 0.96 | 0.97 | 0.88 | 0.78 |
| Reference Example | | | | | | | |

| | | | | | | | |
|---|---|---|---|---|---|---|---|
| Tensile elongation (@23° C.) [%] | 395 | 392 | 381 | 394 | 396 | 380 | 356 |

| | | | | | | | |
|---|---|---|---|---|---|---|---|
| Ratio relative to | 0.83 | 0.83 | 0.80 | 0.83 | 0.83 | 0.80 | 0.75 |
| Reference Example | | | | | | | |

| | | | Comparative | Comparative | Comparative | Comparative | Reference |
|---|---|---|---|---|---|---|---|
| | | | Example 2 | Example 3 | Example 4 | Example 5 | Example |
| Slurry | Fluororesin particles [parts by mass] | | 100 | 100 | 100 | 100 | 100 |
| composition | Carbon nanotubes [parts by mass] | | 0.1 | 0.1 | 0.1 | 1 | — |
| | Dispersion | Ethyl acetate [parts by mass] | — | 400 | — | — | — |
| | medium | Acetone [parts by mass] | — | — | 400 | — | — |
| | | Cyclohexane [parts by mass] | 400 | — | — | 400 | — |
| | | Toluene [parts by mass] | — | — | — | — | — |
| | | p-Xylene [parts by mass] | — | — | — | — | — |
| Production | Jet mill | Pressure [MPa] | 100 | — | — | — | — |
| method | Homogenizer | Rotation speed [rpm] | — | 10000 | 10000 | 10000 | — |
| | | Time [min] | — | 60 | 60 | 60 | — |

| | | | | | | |
|---|---|---|---|---|---|---|
| Evaluation | Area fraction S [%] | 0.23 | 7.8 | 7.5 | 18 | — |
| results | Volume percentage V [%] | 0.128 | 0.128 | 0.128 | 1.28 | — |
| | S/V [—] | 1.8 | 60.9 | 58.6 | 14.1 | — |
| | Surface resistivity [Ω/sq] | 3.1 × 10¹⁵ | 1.6 × 10⁸ | 5 × 10⁸ | 1 × 10² | 5 × 10¹⁵ |
| | Tensile strength (@23° C.) [MPa] | 37.1 | 29.7 | 29 | 28 | 37.3 |

| | | | | | |
|---|---|---|---|---|---|
| Ratio relative to | 0.99 | 0.80 | 0.78 | 0.75 | — |
| Reference Example | | | | | |

| | | | | | |
|---|---|---|---|---|---|
| Tensile elongation (@23° C.) [%] | 472 | 351 | 340 | 260 | 475 |

| | | | | | |
|---|---|---|---|---|---|
| Ratio relative to | 0.99 | 0.74 | 0.72 | 0.55 | — |
| Reference Example | | | | | |

It can be seen from Table 1 that in each of Examples 1 to 6 in which the used slurry contained carbon nanotubes in the prescribed proportion and had a ratio (S/V) of an area fraction S of carbon nanotube aggregates in an image observed under the prescribed conditions and a volume percentage V of carbon nanotubes that was within the prescribed range, a shaped product having excellent tensile strength was obtained compared to Comparative Example 5 in which a slurry containing carbon nanotubes in the prescribed proportion was not used. Moreover, carbon nanotube dispersibility deteriorated, shaped product surface resistivity increased, and shaped product tensile strength decreased in Comparative Examples 1, 3, and 4 as a result of S/V exceeding the prescribed range. Furthermore, the shaped product obtained in Comparative Example 2 had excellent tensile strength but poor surface resistivity as a result of S/V falling below the prescribed range.

### INDUSTRIAL APPLICABILITY

A composite resin material that enables formation of a shaped product having excellent mechanical strength and sufficiently low surface resistivity can be obtained using the presently disclosed slurry.

Moreover, a composite resin material that enables formation of a shaped product having excellent mechanical strength and sufficiently low surface resistivity is obtained through the presently disclosed method of producing a composite resin material.

Furthermore, a shaped product having excellent mechanical strength and sufficiently low surface resistivity is obtained through the presently disclosed method of producing a shaped product.

1. A slurry comprising fluororesin particles, fibrous carbon nanostructures, and a dispersion medium, wherein
the fibrous carbon nanostructures are contained in a proportion of at least 0.01 parts by mass and not more than 0.5 parts by mass per 100 parts by mass of the fluororesin particles, and
an area fraction S, in units of %, of aggregates of the fibrous carbon nanostructures when the slurry is loaded into a glass slide including an indentation of 0.5 mm in depth and inside of the indentation of the glass slide is observed over a range of 3 mm×2 mm using an optical microscope and a volume percentage V, in units of volume %, of the fibrous carbon nanostructures in solid content of the slurry satisfy a relationship: 3≤S/V≤30.

2. The slurry according to claim 1, wherein the fibrous carbon nanostructures have an average diameter of at least 1 nm and not more than 60 nm and an average length of 10 μm or more.

3. The slurry according to claim 1, wherein the fibrous carbon nanostructures exhibit a convex upward shape in a t-plot obtained from an adsorption isotherm.

4. The slurry according to claim 1, wherein the dispersion medium has a Hansen solubility parameter dispersion term dD of at least 16 and not more than 22 and a Hansen solubility parameter hydrogen bonding term dH of at least 0 and not more than 6.

5. The slurry according to claim 1, wherein the dispersion medium is at least one selected from the group consisting of cyclohexane, xylene, methyl ethyl ketone, and toluene.

6. A method of producing a composite resin material comprising a step of removing the dispersion medium from the slurry according to claim 1 to form a composite resin material.

7. A method of producing a shaped product comprising a step of shaping a composite resin material produced using the method of producing a composite resin material according to claim 6.
